(19) United States
(12) Patent Application Publication
(10) Pub. No.: US 2012/0020853 A1
(43) Pub. Date: Jan. 26, 2012

(54) METHOD OF MANUFACTURING ALUMINA BY RECYCLING NICKEL-ALUMINUM

(76) Inventors: Yu-Lung SUN, Kaohsiung City (TW); Yung-Hao Liu, Kaohsiung City (TW); Ming-Zhe Tsai, Kaohsiung CIty (TW)

(21) Appl. No.: 12/898,002

(22) Filed: Oct. 5, 2010

(30) Foreign Application Priority Data
Jul. 26, 2010 (TW) 099124516

(51) Int. Cl. C22B 21/00; C01F 7/02

(52) U.S. Cl. 423/115

(57) ABSTRACT

A method of manufacturing alumina by recycling nickel-aluminum comprises a step of “soaking,” by soaking a purified mineral of nickel-aluminum into an alkaline buffer followed by keeping at an environment of 1 ATM to obtain a rough solution of aluminate; a step of “filtration,” by filtering out a purified mineral of nickel and cobalt from the rough solution of aluminate to obtain a solution of aluminate; a step of “purification,” by adding a de-impurity reagent into the solution of aluminate to remove the impurity of vanadates, molybdates and silicates from the solution of aluminate, in order to obtain a purified solution of aluminate; a step of “sedimentation,” by precipitating out aluminum hydroxide from the purified solution of aluminate; and a step of “calcination,” by calcining the aluminum hydroxide, finally to obtain alumina.

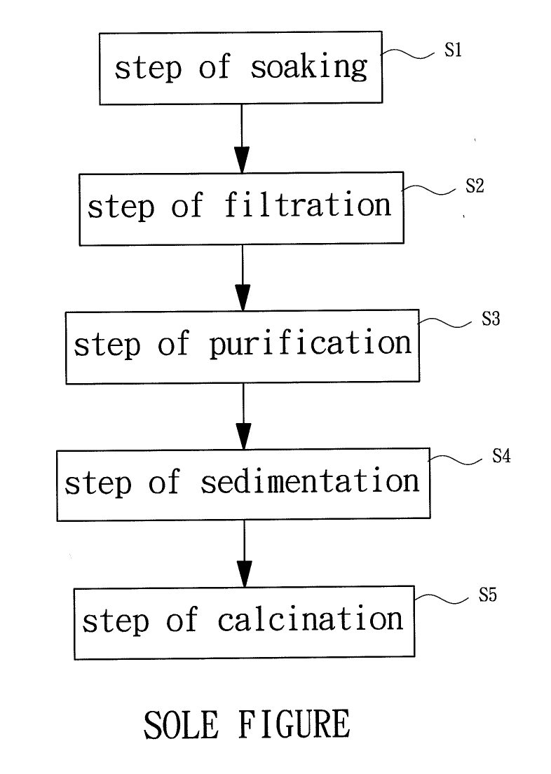

### BACKGROUND OF THE INVENTION

1. Field of the Invention

The present invention relates to a method of manufacturing alumina, particularly to a method of manufacturing alumina by recycling a purified mineral of nickel-aluminum.

2. Description of the Related Art

Alumina, also called aluminum oxide, is a significant mineral source which is widely used as a filler, a catalyst and an abrasive in various industries. The most common and stable form of crystalline alumina is known as α-alumina. The α-alumina can be obtained from aluminum hydroxide when calcined at 950 to 1200° C. On the other hand, alumina can also exist in other phases, like β-alumina, γ-alumina and δ-alumina, wherein the γ-alumina can be transformed into α-alumina under 1200° C.

Generally, the alumina is produced from aluminum-substrates including bauxite, gibbsite, cinder, recycled catalyst and gangue. Recently, due to the response to the environmental protection issue, it is preferable to produce alumina in an economical and eco-friendly manner. Therefore, the recycled catalyst has replaced the other aluminum-substrates to be the primary raw material for alumina manufacturing in recent decades. Among them, a purified mineral of nickel-aluminum recycled from waste residues of RDS is widely used as an aluminate material for industrialized production of alumina. Mainly the purified mineral of nickel-aluminum contains 35˜45% of aluminum, 0.5˜1% of vanadium, 0.3˜0.6% of molybdenum, 3˜4% of nickel, 1.2˜1.6% of silicon and 0.5˜1% of cobalt.

The conventional method of manufacturing alumina comprises a step of “heating,” by mixing the purified mineral of nickel-aluminum with an alkaline powder, such as powder of KOH, NaOH, Ba(OH)₂ or Ca(OH)₂ to obtain a mixture, and then heating the mixture at 1000 to 1200° C.; a step of “soaking,” by dissolving the aluminates, vanadates, molybdates and silicates in the mixture with water, and further taking apart the solution from undissolvable minerals like nickel and cobalt; a step of “purification,” by adding a de-impurity reagent, for example MgO, CaO, Mg(OH)₂ and Ca(OH)₂, in order to remove the impurities of vanadium, molybdenum and silicon from the solution, and to obtain a purified solution of aluminate; a step of “sedimentation,” by precipitating aluminum hydroxide from the purified solution of aluminate via the Bayer process or carbon dioxide process; and a step of “calcination,” by calcining the aluminum hydroxide, finally to obtain alumina.

However, in the conventional method of manufacturing alumina, a significant amount of energy and cost is needed to maintain a temperature of 1000° C. to 1200° C. while heating, which may cause damage to equipment, waste of energy source, and air pollution as well. Meanwhile, in the step of “heating,” the solid phase of the alkaline powder and the purified mineral of nickel-aluminum usually have problems to mix together and interact with each other, which may interfere with the efficiency of the chemical reaction while heating and lower the recycling rate of aluminum. Furthermore, in the conventional method, a complicated process of manufacture has to be gone through to obtain the purified solution of aluminate, which makes the manufacturing a time-consuming and low-efficiency process.

As a result, regarding the disadvantages of the conventional method of manufacturing alumina, there is a need to improve the manufacturing process of alumina by recycling a purified mineral of nickel-aluminum.

### SUMMARY OF THE INVENTION

The primary objective of this invention is to provide a method of manufacturing alumina by recycling nickel-aluminum, which can be processed at low cost and energy so as to be eco-friendly.

The secondary objective of this invention is to provide a shorter process of manufacturing alumina by recycling nickel-aluminum with simple steps, so as to be convenient and highly efficient.

Another objective of this invention is to provide a method of manufacturing alumina by recycling nickel-aluminum that can enhance the interaction between two kinds of substrate so that a high recycling rate of aluminum can be achieved.

A method of manufacturing alumina by recycling nickel-aluminum comprises a step of “soaking,” by soaking a purified mineral of nickel-aluminum into an alkaline buffer followed by keeping at an environment of 1 ATM to obtain a rough solution of aluminate; a step of “filtration,” by filtering out a purified mineral of nickel and cobalt from the rough solution of aluminate to obtain a solution of aluminate; a step of “purification,” by adding a de-impurity reagent into the solution of aluminate to remove the impurity of vanadates, molybdates and silicates from the solution of aluminate, in order to obtain a purified solution of aluminate; a step of “sedimentation,” by precipitating out aluminum hydroxide from the purified solution of aluminate; and a step of “calcination,” by calcining the aluminum hydroxide, finally to obtain alumina.

Further scope of the applicability of the present invention will become apparent from the detailed description given hereinafter. However, it should be understood that the detailed description and specific examples, while indicating preferable embodiments of the invention, are given by way of illustration only, since various modifications will become apparent from this detailed description to those skilled in the art.

### BRIEF DESCRIPTION OF THE DRAWINGS

The present invention will become more fully understood from the detailed description given herein below and the accompanying drawings which are given by way of illustration only, and thus are not limitative of the present invention, and wherein:

SOLE FIGURE is a diagram illustrating a process of manufacturing alumina by recycling nickel-aluminum in the present invention.

In the sole FIGURE of the drawings, the same numerals designate the same or similar parts.

### DETAILED DESCRIPTION OF THE INVENTION

Referring to the sole FIGURE, in accordance with a preferable embodiment of the method of manufacturing alumina by recycling nickel-aluminum, the present invention includes a step of “soaking S1,” a step of “filtration S2,” a step of “purification S3”, a step of “sedimentation S4,” and a step of “calcination S5”.

In the step of “soaking S1,” a purified mineral of nickel-aluminum is prepared and soaked in an alkaline buffer under a pressurized circumstance in order to obtain a rough solution of aluminate. Precisely, the purified mineral of nickel-aluminum in the present invention is ground into granular form to promote the contact surface between the alkaline buffer and the purified mineral of nickel-aluminum during soaking. The purified mineral of nickel-aluminum soaked in the alkaline buffer is then kept under a pressurized circumstance at 150 to 400° C. and >1 MPa, and preferably >1 MPa and <10 MPa, for around 0.5 to 5 hours. Thus, the rough solution of aluminate can be obtained. Generally, the purified mineral of nickel-aluminum is preferably soaked in 0.5 to 3 times the weight of the alkaline buffer in the present invention, wherein the alkaline buffer can be a solution of KOH, NaOH, Ba(OH)₂ or Ca(OH)₂. For example, the granular form of purified mineral of nickel-aluminum is prepared and soaked in 0.5 times the weight of NaOH solution, followed by keeping in an autoclave under 150° C., 1 MPa for 5 hours. The Reaction 1 shown below summarizes the reaction in the step of “soaking S1”.

2Al+2NaOH+2H₂O→2NaAlO₂+3H₂ Reaction 1

In the step of “filtration S2,” nickel and cobalt in the purified mineral of nickel-aluminum are filtered out from the rough solution of aluminate to further obtain a solution of aluminate. Specifically speaking, the rough solution collected from the step of “soaking S1” contains multiple elements of aluminates, vanadates, molybdates, silicates, nickel and cobalt, wherein the nickel and cobalt are indissoluble in the alkaline solution. In the present invention the nickel and cobalt are filtered out by a plate filtration or a pocket filtration. As an example of the preferable embodiment in the present invention, the rough solution of aluminate obtained from the step of “soaking S1” is filtered through a plate filtration to filter out the nickel and cobalt, thereby obtaining a solution of aluminate.

In the step of “purification S3”, a de-impurity reagent is added to the solution of aluminate in order to dispose of the impurities including vanadates, molybdates and silicates from the solution of aluminate. Then, a purified solution of aluminate can be obtained. Particularly, in the step of “filtration S2,” only a primary isolation of solid and liquid is processed so that the de-impurity reagent is needed to further separate the vanadates, molybdates and silicates from the solution of aluminate. In the present invention, the de-impurity reagent is a chemical composition of MX, wherein the “M” can be calcium, magnesium, barium or strontium, and the “X” can be oxide, hydride, chloride or sulfide oxide. In the present invention, it is preferable but not limited to add 0.1˜0.3 times of de-impurity reagent to the solution of aluminate for the clarification. For example, in the preferable embodiment of the present invention, calcium oxide or calcium hydride is added to the solution of aluminate as the de-impurity reagent to remove the vanadates, molybdates and silicates. In this way, the purified solution of aluminate can be collected and used as a material for manufacturing alumina in the following step. The Reaction 2 summarizes the chemical reaction performed in the step of “purification S3”.

2Al+2ROH+O₂→2RAlO₂+H₂ (R can be K, Na, Ba and Cs) Reaction 2

In the step of “sedimentation S4,” an aluminum hydroxide can be precipitated via the Bayer process or carbon dioxide process. According to the Reaction 3 summarized below, the aluminum hydroxide and sodium hydroxide are obtained in the step of “sedimentation S4,” wherein the sodium hydroxide can be reused as the alkaline buffer in the step of “soaking.”

Al₃+3NaAlO₂+6H₂O→Al(OH)₃+3NaOH Reaction 3

In the step of “calcination S5,” the aluminum hydroxide collected from the step of “sedimentation S4” is calcined to finally obtain a product of alumina. More precisely, the alumina, known as α-type alumina, can be obtained while the aluminum hydroxide is calcined at 950 to 1200° C., or dehydrogenized at 140 to 150° C., followed by consistent heating till 1200° C. With the preferable embodiment in the present invention, the aluminum hydroxide is first calcined at 300° C. via dehydrogenation to obtain γ-type alumina. Then, the γ-type alumina is consistently heated at 1200° C. to transform it into α-type alumina. The Reaction 4 shown below summarized the chemical reaction in the step of “calcination S5”.

2Al(OH)₃→Al₂O₃+3H₂O Reaction 4

In the present invention, due to the vapor pressure of the alkaline buffer produced when heating till the critical temperature, metal mines (including aluminum, vanadium, molybdenum and silicon) in the purified mineral of nickel-aluminum and the alkaline buffer are capable to react upon each other under a circumstance of <400° C. As a result, a high temperature (approximate >800° C.) of the reaction between the alkaline buffer and metal mines may no longer be needed in the step of “soaking S1”. Yet, it is sufficient to promote the efficiency of the interaction between the solid phase of metal mines and liquid phase of alkaline buffer in the step of “soaking S1” so that a good performance of the recycling rate of aluminum can be obtained. In the present invention, about 84.5% of aluminum can be recycled using a soaking process at 150° C. and 1 MPa. Also, around 94.5% and 98.5% of recycling rate of aluminum will be achieved when the soaking process takes place under circumstances of 200° C., 6 MPa, and 400° C., 10 MPa respectively.

In summary, the recycling of the aluminate solution can be achieved in an eco-friendly and economical way in the step of “soaking” of the present invention so that the cost and energy resource of the manufacture, as well as the pollution problem, can be reduced. Moreover, according to the step of “soaking” in present invention, the manufacture of alumina can be simplified, therefore, a complicated process will no longer be necessary. Finally, due to the good interaction between the solid phase of the purified mineral of nickel-aluminum and the liquid phase of the alkaline buffer in the step of “soaking”, the efficiency of the manufacture of alumina is dramatically improved so that a higher production of alumina can be obtained.

Although the invention has been described in detail with reference to its presently preferred embodiment, it will be understood by one of ordinary skill in the art that various modifications can be made without departing from the spirit and the scope of the invention, as set forth in the appended claims.

1. A method of manufacturing alumina by recycling nickel-aluminum comprising the steps of:
soaking a purified mineral of nickel-aluminum into an alkaline buffer followed by keeping at a pressurized an environment of to 10 MPa and a temperature of 150 to 400° C. to obtain a rough solution of aluminate;
filtering out a purified mineral of nickel and cobalt from the rough solution of aluminate to obtain a solution of aluminate;
adding a de-impurity reagent into the solution of aluminate to remove the impurity of vanadates, molybdates and silicates from the solution of aluminate, in order to obtain a purified solution of aluminate;
precipitating out aluminum hydroxide from the purified solution of aluminate; and
calcining the aluminum hydroxide, finally to obtain alumina.

2. (canceled)

3. (canceled)

4. The method of manufacturing alumina by recycling nickel-aluminum as defined in claim 1, wherein a step of controlling the reactive time to last from 0.5 to 5 hours is performed before the step of soaking.

5. The method of manufacturing alumina by recycling nickel-aluminum as defined in claim 1, wherein a step of mixing the purified mineral of nickel-aluminate with 0.5 to 3 times the weight of the alkaline buffer is performed before the step of soaking.

6. The method of manufacturing alumina by recycling nickel-aluminum as defined in claim 1, wherein a step of selecting a chemical composition of MX as the de-impurity reagent in which the M is selected from a group of calcium, magnesium, barium and strontium, and the X is selected from a group of oxygen, hydroxide, chloride and sulfate is performed before the step of purification.

7. The method of manufacturing alumina by recycling nickel-aluminum as defined in claim 1, wherein a step of selecting the alkaline buffer from a group of KOH, NaOH, CsOH, Ba(OH)₂, Ca(OH)₂ and Mg(OH)₂ is performed before the step of soaking.
